(19) United States
(12) Patent Application Publication
(10) Pub. No.: US 2006/0281428 A1
(43) Pub. Date: Dec. 14, 2006

(54) System and method for transmitting radio signals via cable television broadband networks

(76) Inventors: Chih-Hao Chen, Hsinchu (TW); Jei-Mei Feng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/149,295

(22) Filed: Jun. 10, 2005

(51) Int. Cl. H04B 15/00

(52) U.S. Cl. 455/253.1; 455/62

(57) ABSTRACT

A system for transmitting radio signals via cable television broadband networks includes a wireless access device, an adapter device and a plurality of distributing devices. The wireless access device is disposed in one of spaces for receiving and transmitting radio signals. The adapter device has a first input side for receiving the radio signals, a second input side for receiving cable television broadband signals, and an output side for outputting mixing signal that compose of the radio signals and the cable television broadband signals. The distributing devices are disposed respectively in the spaces, and connected in sequence. Each of the distributing device has a mixing signal input side for receiving the mixing signals, an antenna for outputting the radio signals, a connector for outputting the cable television broadband signals, and a mixing signal output side for outputting the mixing signals to the mixing signal input side of another distributing device.

### BACKGROUND OF THE INVENTION

1. Field of The Invention

The present invention relates to a system and method for transmitting radio signals via cable television broadband networks, and particularly relates to a system having a wireless access device for receiving radio signals, an adapter device for receiving the radio signals from the wireless access device, and distributing devices connecting in sequence and respectively disposed in different spaces for receiving the radio signals. Hence, the radio signals cannot be limited and impeded, and can be transmitted to every space.

2. Description of the Related Art

According to developments of the present information, it is popular to design a network system in office or home. In convention, signals can be transmitted in the office or home via a local area network. Although signals are transmitted via the local area network without losing, it is time-consuming to layout network cables of the local area network and the dense network cables occupy many spaces in the office or the home.

In order to solve the above-mentioned problem, an access point (AP) is provided for transmitting signals to a computer with a wireless receiver by a wireless method. However, when the computer with the wireless receiver is far from the AP, the wireless receiver of the computer cannot receive the signals from the AP.

FIG. 1 shows a block diagram of system for transmitting radio signals according to the prior art. The system includes a cable modem 1a, a Hub 2a and a plurality of access points (APs) 3a, 4a and 5a. Both the cable modem 1a and the Hub 2a are disposed in a space 100a. The APs 3a, 4a and 5a are disposed in spaces 100a, 200a and 300a, respectively. Moreover, the cable modem 1a has an input side for receiving mixing signals that compose of radio signals (radio frequency) and cable television broadband signals, a first output side for transmitting the radio signals to the Hub 2a, and a second output side for transmitting the cable television broadband signals to TVs 10a, 20a and 30a. The Hub 2a is used to transmit and distribute the radio signals to APs 3a, 4a and 5a, respectively. Hence, computers 10b and 20b with wireless receivers can receive the radio signals via the AP 3ain the space 100a, computer 30b with wireless receiver can receive the radio signals via the AP 4a in the space 200a, and computer 40b with wireless receiver can receive the radio signals via the AP 5a. However, it is costing much money to use many APs 3a, 4a and 5a, and it is time-consuming to layout network cables between the Hub 2a and each of APs 3a, 4a and 5a.

### SUMMARY OF THE INVENTION

The present invention provides a system and method for transmitting radio signals via cable television broadband networks. The system can be used to transmit radio signals and cable television broadband signals to different spaces via cable television broadband networks by wire or wireless method.

One aspect of the invention is a system for transmitting radio signals via cable television broadband networks. The system includes a wireless access device, an adapter device and a plurality of distributing devices. The wireless access device is disposed in one of spaces for receiving and transmitting radio signals. The adapter device has a first input side electrically connecting with the wireless access device for receiving the radio signals, a second input side for receiving cable television broadband signals, and an output side, wherein the radio signals and the cable television broadband signals are mixed together to form mixing signals. The distributing devices are disposed respectively in the spaces, and connected in sequence. Each of the distributing device has a mixing signal input side for receiving the mixing signals, at least one antenna for outputting the radio signals to at least one electrical device with a wireless receiving device, at least one connector for outputting the cable television broadband signals to at least one display device, and a mixing signal output side for outputting the mixing signals to the mixing signal input side of another distributing device, wherein the mixing signal input side of one of the distributing devices is used to receive the mixing signals from the output side of the adapter device and the output side of the adapter device.

One aspect of the invention is a method for transmitting radio signals via cable television broadband networks. The method includes receiving radio signals via a wireless access device, wherein the wireless access device is disposed in one of spaces; transmitting the radio signals from the wireless access device and cable television broadband signals to an adapter device; mixing the radio signals and the cable television broadband signals to form mixing signals via the adapter device; transmitting the mixing signals to a distributing device, wherein the distributing device has at least one antenna and connector; and separating the mixing signals into the radio signals and the cable television broadband signals, and transmitting the mixing signals to another distributing device disposed in another space, wherein the radio signals are outputted to at least one electrical device via the at least one antenna, and the cable television broadband signals are outputted to at least one display device via the at least one connector.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawings, in which:

FIG. 1 is a block diagram of system for transmitting radio signals according to the prior art;

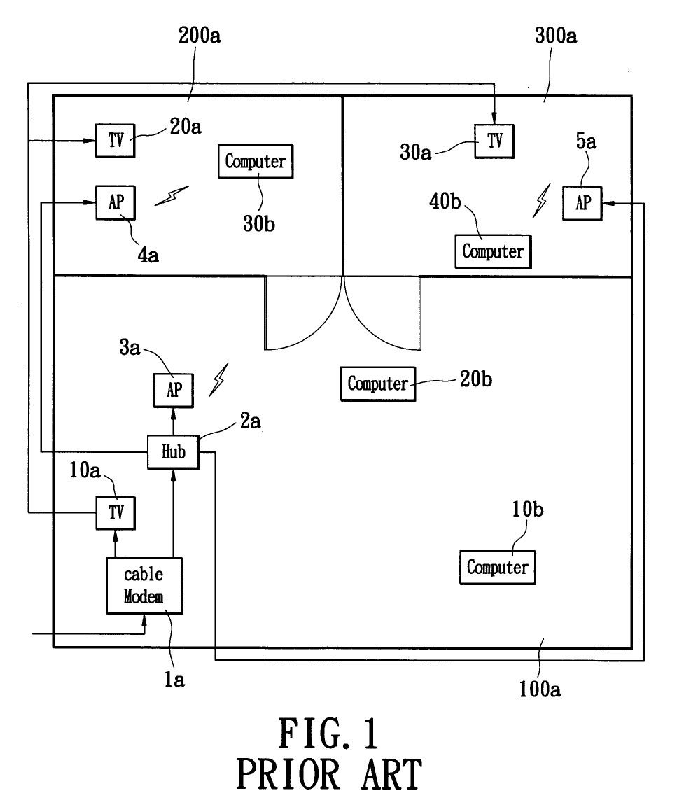

FIG. 2 is a block diagram of system for transmitting radio signals via cable television broadband networks according to the present invention;

FIG. 3 is an application diagram of system for transmitting radio signals via cable television broadband networks according to the present invention;

FIG. 4 is a block diagram of an adapter device and a distributing device electrically connected to each other according to the present invention; and

FIG. 5 is a flow chat of method for transmitting radio signals via cable television broadband networks according to the present invention.

### DETAILED DESCRIPTION OF PREFERRED EMBODIMENTS

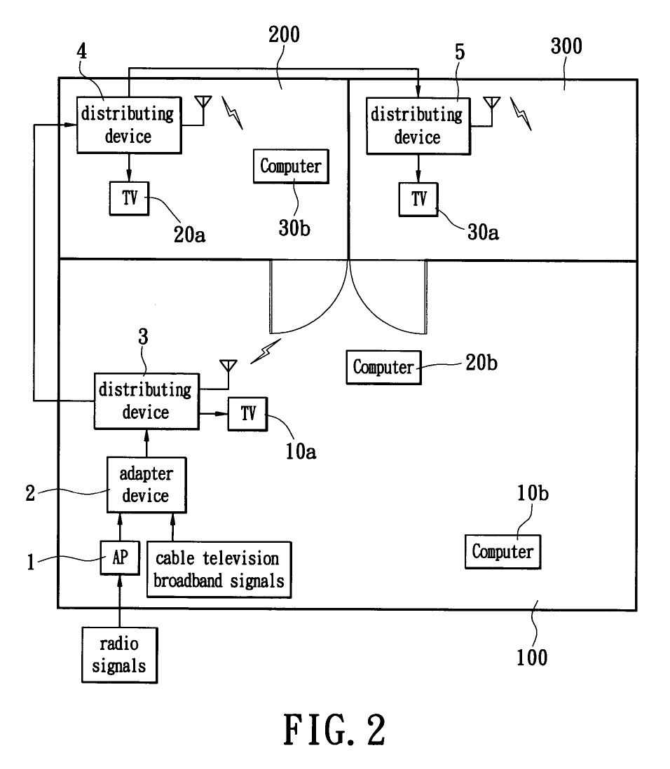

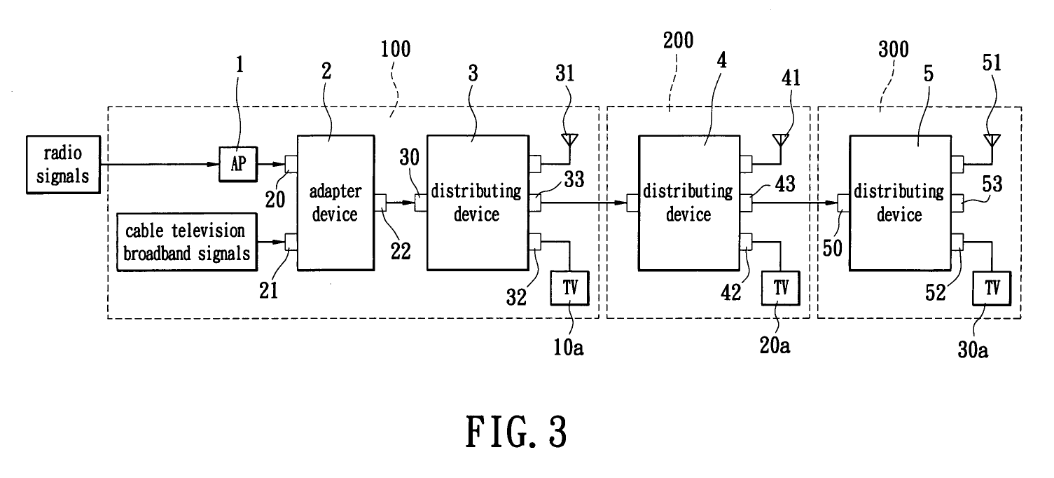

FIGS. 2 and 3 are show a block diagram and an application diagram of system for transmitting radio signals via cable television broadband networks according to the present invention, respectively. The present invention provides a system for transmitting radio signals via cable television broadband networks. The system includes a wireless access device 1, an adapter device 2 and a plurality of distributing devices 3, 4 and 5.

The wireless access device 1 can be a wireless access point (AP). The wireless access device 1 is disposed in a space 100 for receiving and transmitting radio signals. The adapter device 2 has a first input side 20 electrically connecting with the wireless access device 1 for receiving the radio signals, a second input side 21 for receiving cable television broadband signals, and an output side 22 for outputting mixing signals that compose of the radio signals and the cable television broadband signals are mixed together to form mixing signals.

The distributing devices 3, 4 and 5 are disposed respectively in the spaces 100, 200 and 300, and are connected in sequence. Each of the distributing devices 3, 4 and 5 has a mixing signal input side (30, 40 and 50) for receiving the mixing signals, at least one antenna (31, 41 and 51) for outputting the radio signals to at least one electrical device (such as computer 10b, 20b, 30b and 40b) with a wireless receiving device, at least one connector (32, 42 and 52) for outputting the cable television broadband signals to at least one display device (such as TV 10a, 20a and 30a), and a mixing signal output side (33, 43 and 53) for outputting the mixing signals to the mixing signal input side of another distributing device. The electrical device can be a notebook or a laptop.

For example, the mixing signals are outputted from the mixing signal output side 33 to the mixing signal input side 40. Hence, the mixing signal input side 30, 40 and 50 of one of the distributing devices 3, 4 and 5 can be used to receive the mixing signals from the output side 22 of the adapter device 2 and the output side 33 and 43 of the adapter device 3 and 4.

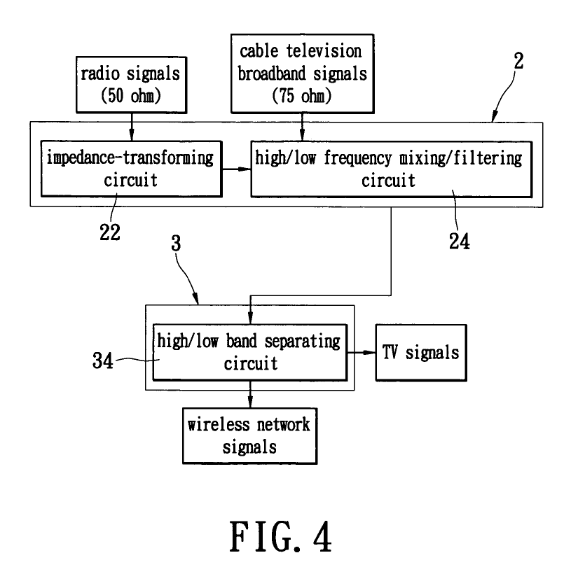

FIG. 4 shows a block diagram of an adapter device and a distributing device electrically connected to each other according to the present invention. The adapter device 2 has an impedance-transforming circuit 23 and a high/low frequency mixing/filtering circuit 24 connected to each other. In this embodiment, the high frequency is about 2.4 G˜5.8 GHz and the low frequency is about 5 M˜750 MHz, and the impedance of the radio signals can be about 50 ohm and the impedance of the cable television broadband signals can be about 75 ohm. The impedance of the radio signals is transformed from 50 ohm into 75 ohm that is same to the impedance of the cable television broadband signals. The high/low frequency mixing/filtering circuit 23 is used to mix the radio signals and the cable television broadband signals to form mixing signals. Moreover, each of distributing devices 3 has a high/low band separating circuit 34 for separating the mixing signals into TV signals (the radio signals) and wireless network signals (the cable television broadband signals).

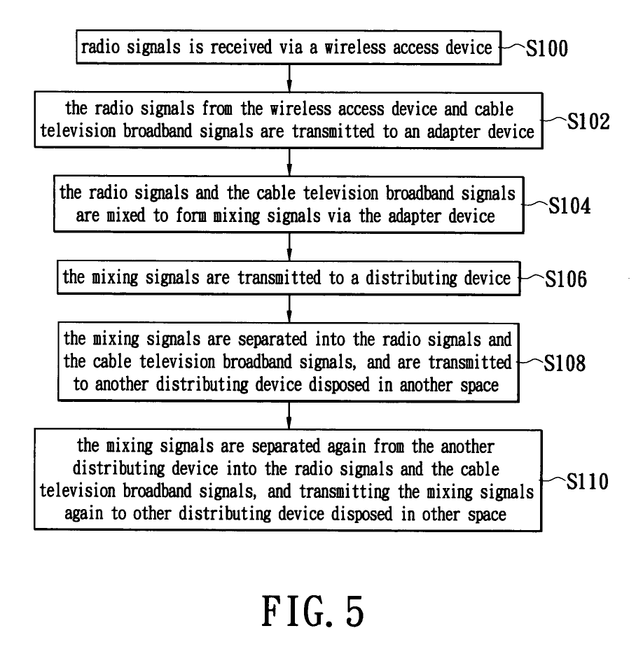

FIG. 5 shows a flow chat of method for transmitting radio signals via cable television broadband networks according to the present invention. The method includes following steps. Firstly, radio signals is received via a wireless access device 1 (S100), wherein the wireless access device 1 is disposed in spaces 100. The radio signals from the wireless access device 1 and cable television broadband signals are transmitted to an adapter device 2 (S102). Thereafter, the radio signals and the cable television broadband signals are mixed to form mixing signals via the adapter device 2 (S104).

Moreover, the mixing signals are transmitted to a distributing device 3 (S106), wherein the distributing device 3 has at least one antenna 31 and connector 32. The mixing signals are separated into the radio signals and the cable television broadband signals, and are transmitted to another distributing device 4 disposed in another space 200 (S108), wherein the radio signals are outputted to at least one electrical device (such as the computer 10a, 20a and 30a) via the at least one antenna (31 and 41), and the cable television broadband signals are outputted to at least one display device (such as the TV 10a and 20a ) via the at least one connector (32 and 42). Thereafter, the mixing signals are separated again from another distributing device 4 into the radio signals and the cable television broadband signals, and transmitting the mixing signals again to other distributing device 5 disposed in other space 300 (S110).

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A system for transmitting radio signals via cable television broadband networks, comprising:
a wireless access device disposed in one of spaces for receiving and transmitting radio signals;
an adapter device having a first input side electrically connecting with the wireless access device for receiving the radio signals, a second input side for receiving cable television broadband signals, and an output side, wherein the radio signals and the cable television broadband signals are mixed together to form mixing signals; and
a plurality of distributing devices disposed respectively in the spaces, and connected in sequence, wherein each of the distributing device has a mixing signal input side for receiving the mixing signals, at least one antenna for outputting the radio signals to at least one electrical device with a wireless receiving device, at least one connector for outputting the cable television broadband signals to at least one display device, and a mixing signal output side for outputting the mixing signals to the mixing signal input side of another distributing device, wherein the mixing signal input side of one of the distributing devices is used to receive the mixing signals from the output side of the adapter device and the output side of the adapter device.

2. The system as claimed in claim 1, wherein the electrical device is a computer, a notebook or a laptop.

3. The system as claimed in claim 1, wherein the display device is a television.

4. The system as claimed in claim 1, wherein the wireless access device is a wireless access point (AP).

5. The system as claimed in claim 1, wherein the adapter device comprises an impedance-transforming circuit for impedances of the radio signals being transformed to that of the cable television broadband signals, and a high/low frequency mixing/filtering circuit connecting with the impedance-transforming circuit for mixing the radio signals and the cable television broadband signals.

6. The system as claimed in claim 1, wherein each of distributing devices has a high/low band separating circuit for separating the mixing signals into the radio signals and the cable television broadband signals.

7. A method for transmitting radio signals via cable television broadband networks, comprising:
receiving radio signals via a wireless access device, wherein the wireless access device is disposed in one of spaces;
transmitting the radio signals from the wireless access device and cable television broadband signals to an adapter device;
mixing the radio signals and the cable television broadband signals to form mixing signals via the adapter device;
transmitting the mixing signals to a distributing device, wherein the distributing device has at least one antenna and connector; and
separating the mixing signals into the radio signals and the cable television broadband signals, and transmitting the mixing signals to another distributing device disposed in another space, wherein the radio signals are outputted to at least one electrical device via the at least one antenna, and the cable television broadband signals are outputted to at least one display device via the at least one connector.

8. The method as claimed in claim 7, further comprising separating the mixing signals from the another distributing device into the radio signals and the cable television broadband signals, and transmitting the mixing signals to other distributing device disposed in other space.
